(19) United States
(12) Patent Application Publication
(10) Pub. No.: US 2020/0404884 A1
(43) Pub. Date: Dec. 31, 2020

(54) METHOD AND APPARATUS FOR DONNING A FLEXIBLE COVERING ON AN ANIMAL LIMB

(71) Applicant: Alison Christine Gibbins, Toronto (CA)

(72) Inventor: Alison Christine Gibbins, Toronto (CA)

(21) Appl. No.: 16/907,205

(22) Filed: Jun. 20, 2020

Related U.S. Application Data
(60) Provisional application No. 62/868,124, filed on Jun. 28, 2019.

(51) Int. Cl. A01K 13/00; A43C 19/00

(52) U.S. Cl. CPC A01K 13/007; A43C 19/00

(57) ABSTRACT

An apparatus and method for donning a flexible covering on an animal limb, the flexible covering including a top open mouth defined by a lip. The apparatus comprises a rigid ring having an outer face around which the mouth of the flexible covering can be positioned. The ring comprises one or more protrusions disposed along the outer face of the ring that are adapted to secure the mouth of the flexible covering in an open position and a linear indentation situated on the outer face of the ring that is adapted to accommodate the lip of the flexible covering. The method includes the steps of stretching the mouth of the flexible covering around the outer face of the ring; aligning the lip of the flexible covering with the linear indentation on the ring; guiding the animal limb through the ring and into the flexible covering; releasing the flexible covering from the ring; and removing the ring from the animal limb.

### FIELD OF THE INVENTION

The present invention relates generally to an apparatus and method for donning a flexible covering on an animal limb. In particular, the invention relates to an apparatus and method for donning a disposable, elastomeric boot on a canine paw.

### BACKGROUND OF THE INVENTION

Protective coverings for animal limbs are desired or required in many situations. Notably, many owners of domesticated animals want to protect their animals' paws from inclement weather, chemicals, debris, and other harmful elements. The prior art discloses a myriad of boots, socks, and other coverings developed to protect animal paws against these hazards.

A typical paw covering disclosed by the prior art resembles a human-like shoe, comprising fabric stitched over a padded sole and a Velcro, zipper or strap closure. This type of conventional covering presents the following problems: it is expensive; it is generally not waterproof; it easily detaches from the animal's limb; and it feels unnatural to the animal, which makes the animal less sure-footed.

In view of the above problems, a solution was presented in U.S. Pat. No. 8,360,012, which discloses a disposable, waterproof canine boot, comprising a single, seamless piece of material having a bulbously shaped, bottom closed end and a top open mouth of smaller cross-section. The boot is made of elastic, lightweight material, such as latex, which provides a natural feel for the dog and allows the boot to remain reliably secured to the dog's limb. Owing to these advantages, the boot shown in U.S. Pat. No. 8,360,012 has gained significant popularity with dog owners in recent years.

Although the boot disclosed in U.S. Pat. No. 8,360,012 confers many advantages over the prior art, it does present one drawback: it is difficult for a dog owner to don the boot on their pet's paw without the assistance of others. Owing to its rubbery material and constricted mouth, the boot must be stretched open—normally with two hands—in order to be slipped over a dog's paw. It is challenging for one person to coordinate both stretching open the boot and slipping the boot over the dog's paw. As a result, the donning process generally requires two people, which is inefficient and impractical for many dog owners.

At present, there is only one device available on the market that is designed facilitate this donning process. Said device is a tong-like tool, which is configured to stretch and secure the mouth of the canine boot in an open position. The tool was designed with the intention of allowing users to open the mouth of the boot with one hand—by employing the tool's tongs—while using the other free hand to guide the dog's paw into the boot. However, for the following reasons, among others, users of this tool have found that it does not fulfill its purpose: first, it takes a great deal of force to open the mouth of the boot with the tongs, with the process being unreasonably strenuous for the average person; second, depending on the size of the dog, the tongs often do not open wide enough to fit around the dog's paw; and third, the tool does not adequately grip the boot—the boot commonly slips off the tool before the boot is fixed around the dog's paw.

Accordingly, there remains a need for improvements in the art.

### SUMMARY OF THE INVENTION

In accordance with an aspect of the invention, there is provided an apparatus for donning a flexible covering on an animal limb.

According to an embodiment of the invention, the present invention provides an apparatus for donning a flexible covering on an animal limb, the flexible covering including a top open mouth defined by a lip, comprising: a rigid ring having an outer face around which the mouth of a flexible covering can be positioned, wherein the ring has an inner circumference sized to allow the animal limb to fit through the ring, and wherein the ring comprises one or more protrusions disposed along the outer face of the ring that are adapted to secure the mouth of the flexible covering in an open position, and wherein the ring comprises a linear indentation situated on the outer face of the ring that is adapted to accommodate the lip of the flexible covering.

According to a further embodiment, the present invention provides a method for donning a flexible covering on an animal limb, the flexible covering including a top open mouth defined by a lip, the method comprising: stretching the mouth of the flexible covering around an outer face of a ring; aligning the lip of the flexible covering with a linear indentation on the ring; guiding the animal limb through the ring and into the flexible covering; releasing the flexible covering from the ring by removing the lip of the flexible covering from the outer face of the ring; and removing the ring from the animal limb by guiding it over the flexible covering and away from the animal limb.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a top, front perspective view of an apparatus for donning a flexible covering on an animal limb according to a first embodiment of the present invention.

FIG. 2 is a top perspective view of the apparatus of FIG. 1.

FIG. 3 is a top, rear perspective view of the apparatus of FIG. 1.

FIG. 4 is a rear perspective view of the apparatus of FIG. 1.

FIG. 5 is a side orthogonal view of the apparatus of FIG. 1.

FIG. 6 is a perspective view of an apparatus for donning a flexible covering on an animal limb according to a second embodiment of the present invention.

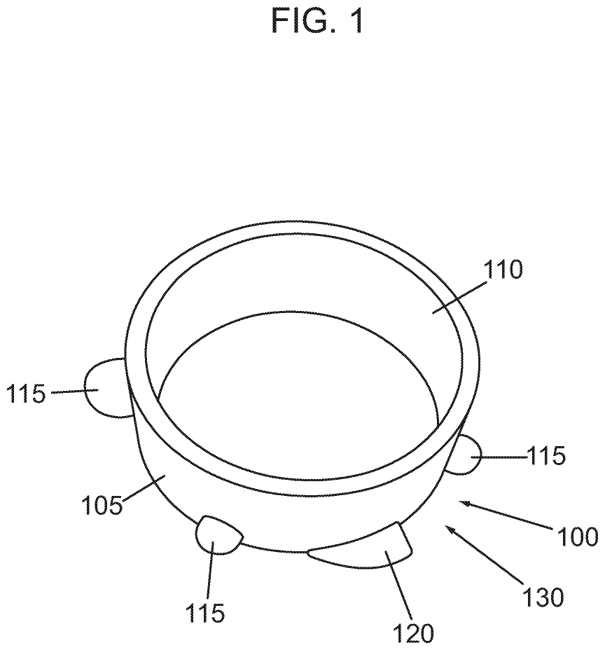

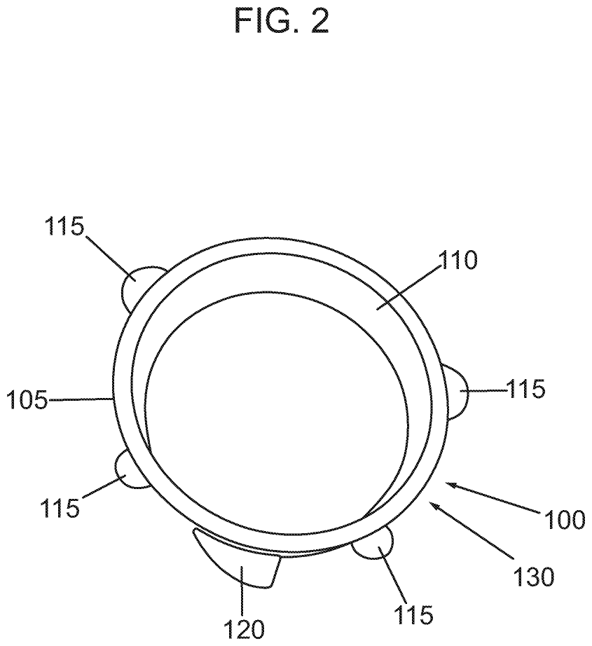

Appendix A contains a series of snapshots that depict a method for donning a flexible covering on an animal limb using the apparatus of FIG. 1.

### DETAILED DESCRIPTION OF THE EMBODIMENTS

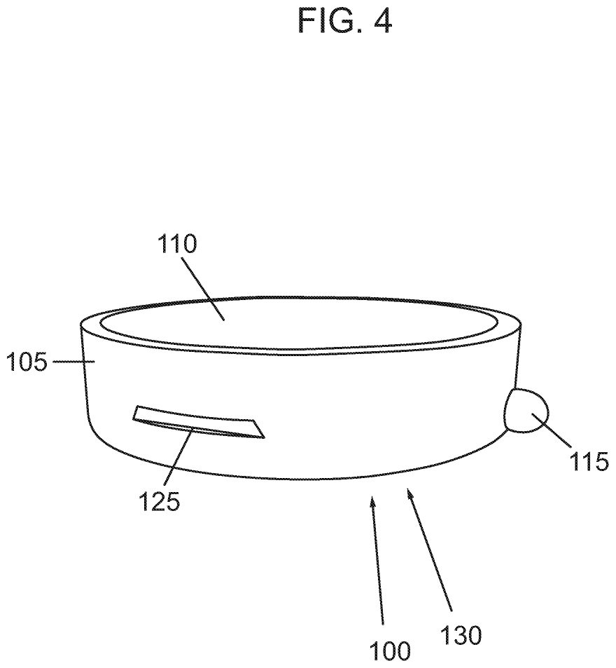

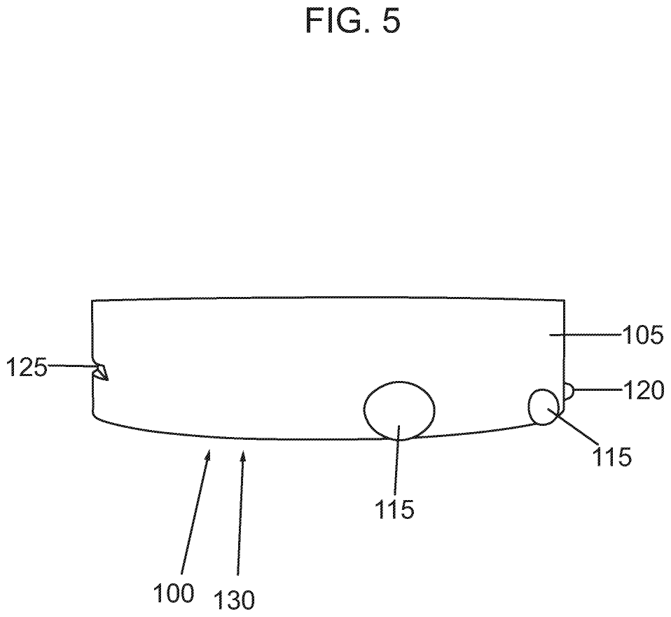

Referring to FIGS. 1-5, an apparatus for donning a flexible covering on an animal limb according to a first embodiment of the invention is shown generally at 100. The apparatus 100 may be composed of hard plastic, metal, or any other suitable material of sufficient strength to prevent deformation of the apparatus during use.

As illustrated in FIGS. 1-4, the apparatus 100 comprises a ring, indicated at 130. Ring 130 comprises an inner face 110, which is suitably sized to allow for the passage of an animal limb. The apparatus 100 may further comprise protrusions 115 and 120, which are disposed along an outer face 105. The outer face 105 is suitably sized to fit within the mouth of a flexible covering. As will be more fully described below, protrusions 115 and 120 are adapted to secure the mouth of a flexible covering in an open position. Protrusions 115 may be substantially spherical in shape. Protrusion 120 may be substantially flat, having at least two substantially planar faces that are substantially parallel to each other. It will be appreciated that protrusions of diverse shapes may be useful, such as elliptical or triangular.

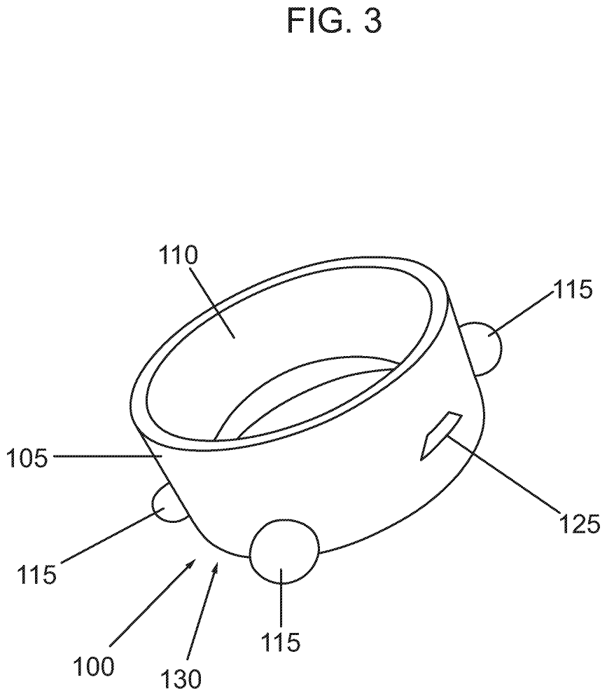

Referring to FIGS. 3-5, the apparatus 100 may further comprise a linear indentation 125, which is adapted to accommodate the lip of a flexible covering. As will be more fully described below, linear indentation 125 assists in securing the mouth of the flexible covering to the apparatus 100 in an open position. It will be appreciated that linear indentations of varying lengths may be useful.

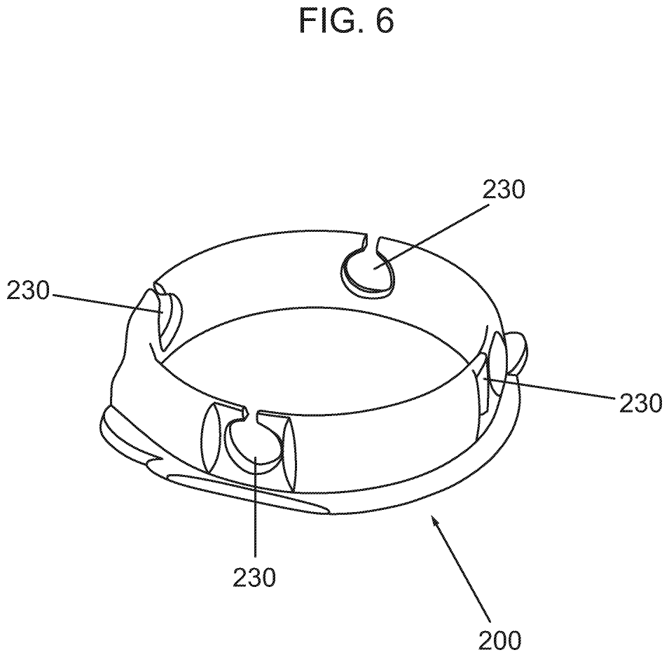

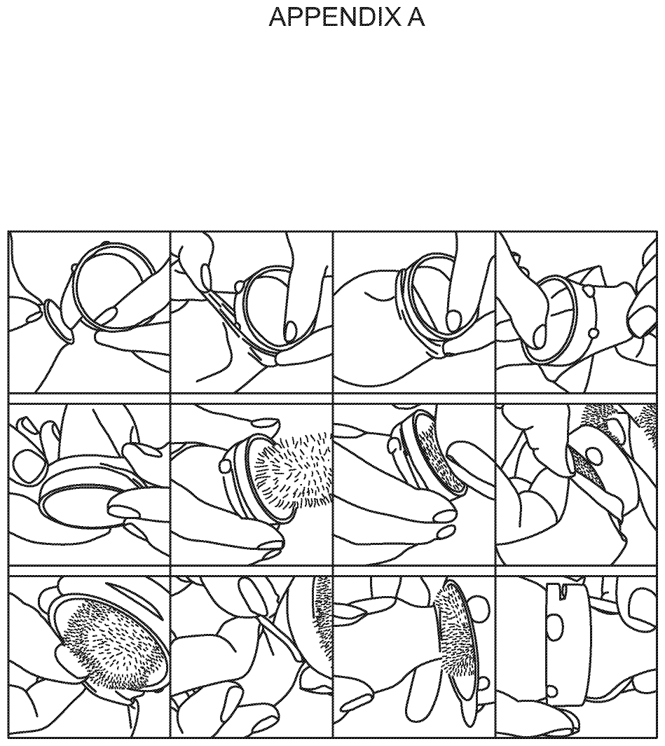

According to a further embodiment as shown in FIG. 6, a donning apparatus 200 may comprise notches 230, which are adapted to secure at least one flexible covering to the ring when not in use.

According to a further embodiment, when apparatus 100 is in use, the mouth of a flexible covering may be stretched around the outer face 105 of the ring 130. Next, the lip of the flexible covering may be aligned with linear indentation 125, effectively securing the mouth of the flexible covering to the ring 130 in an open position. While grasping the apparatus 100 and open flexible covering in one hand, a user may guide an animal's limb through the inner circumference of ring 130 and into the flexible covering with the other hand. The flexible covering may then be released from the ring 130 by removing the lip of the flexible covering from the outer face 105 of the ring. Lastly, the ring 130 may be removed from the animal limb by guiding it over the flexible covering and away from the animal limb.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. An apparatus for donning a flexible covering on an animal limb, the flexible covering including a top open mouth defined by a lip, comprising:
a rigid ring having an outer face around which the mouth of the flexible covering can be positioned,
wherein the ring has an inner circumference sized to allow the animal limb to fit through the ring,
and wherein the ring comprises one or more protrusions disposed along the outer face of the ring that are adapted to secure the mouth of the flexible covering in an open position,
and wherein the ring comprises a linear indentation situated on the outer face of the ring that is adapted to accommodate the lip of the flexible covering.

2. The apparatus of claim 1, wherein the flexible covering is composed of elastomeric material.

3. The apparatus of claim 2, wherein the elastomeric material is latex.

4. The apparatus of claim 1, wherein the animal is a domesticated animal.

5. The apparatus of claim 4, wherein the domesticated animal is a dog.

6. The apparatus of claim 1, wherein the ring is composed of plastic.

7. The apparatus of claim 1, wherein the ring is composed of metal.

8. The apparatus of claim 1, wherein one or more of the protrusions is substantially spherical in shape.

9. The apparatus of claim 1, wherein one or more of the protrusions is substantially flat, having at least two substantially planar faces that are substantially parallel to each other.

10. The apparatus of claim 1, wherein the ring comprises one or more notches adapted to secure at least one flexible covering to the ring when not in use.

11. A method for donning a flexible covering on an animal limb, the flexible covering including a top open mouth defined by a lip, comprising:
stretching the mouth of the flexible covering around an outer face of a ring;
aligning the lip of the flexible covering with a linear indentation on the ring;
guiding the animal limb through the ring and into the flexible covering;
releasing the flexible covering from the ring by removing the lip of the flexible covering from the outer face of the ring;
removing the ring from the animal limb by guiding it over the flexible covering and away from the animal limb.

12. The method of claim 11, wherein the ring comprises one or more protrusions disposed along the outer face of the ring that are adapted to secure the mouth of the flexible covering in an open position.

13. The method of claim 12, wherein one or more of the protrusions is substantially spherical in shape.

14. The method of claim 12, wherein one or more of the protrusions is substantially flat, having at least two substantially planar faces that are substantially parallel to each other.

15. The method of claim 11, wherein the step of securing the mouth of the flexible covering to the ring in an open position comprises securing the mouth of the flexible covering to one or more protrusions on the outer face of the ring.

16. The method of claim 11, wherein the flexible covering is composed of polymeric material.

17. The method of claim 12, wherein the polymeric material is latex.

18. The method of claim 11, wherein the ring is composed of plastic.

19. The method of claim 11, wherein the ring is composed of metal.

20. The method of claim 11, wherein the ring comprises one or more notches adapted to secure at least one flexible covering to the ring when not in use.
